(19) United States
(12) Patent Application Publication
(10) Pub. No.: US 2009/0230120 A1
(43) Pub. Date: Sep. 17, 2009

(54) Welding head carrier for use in welding inner surface of tube

(75) Inventors: Jun Seog Yang, Seoul (KR); Tae Ryong Kim, Daejeon (KR); Seung Young Yoo, Gyeongsangnam-do (KR); Suk Soon Choi, Seoul (KR)

Correspondence Address: IPHORGAN, LTD., 1130 LAKE COOK ROAD, SUITE 240, BUFFALO GROVE, IL, 60089, US

(73) Assignee: Korea Electric Power Corporation, Seoul (KR)

(21) Appl. No.: 12/077,017

(22) Filed: Mar. 14, 2008

(51) Int. Cl. B23K 37/02; B23K 9/028

(52) U.S. Cl. 219/60 A; 228/29

(57) ABSTRACT

A welding head carrier for use in welding the inner surface of a tube includes inter alia a welding head provided with a welding torch and a camera, a wireless camera mounted at the inner side of the tube to monitor whether cables are entangled, a wireless receiver for receiving wirelessly an image from the wireless camera, including a camera controller for controlling the camera and the wireless receiver, display for displaying the welding operation and the inside of the tube. Fixing units can be adjusted in length depending on the size of the tube, thus eliminating the need for the rebuilding or replacement of the welding head carrier, leading to cost savings. The welding head can be easily mounted, regardless of size and configuration of the welding head, and the range of use of the welding head carrier can be extended.

### BACKGROUND OF THE INVENTION

1. Field of the Invention

The present invention relates generally to a welding head carrier for use in welding the inner surface of a tube and more specifically relates to a welding head carrier that can be used in welding the inner surface of a connecting portion of a main tube (i.e. a reactor coolant loop) when a steam generator of a nuclear power plant is replaced with a new one.

2. Description of the Related Art

In general, a steam generator of a nuclear power plant is one of the most crucial units for generating steam required to produce electric power from a steam turbine and a power generator, and allows a high-temperature, high-pressure radioactive primary coolant from a nuclear reactor to flow through a tube such that cold feed water surrounding the tube is heated to generate steam, after which the steam is supplied to the turbine.

When it is intended to replace the steam generator with a new one, welding is conducted after the steam generator is put into operation. As a result, radioactive contamination around the steam generator is inevitable, which causes limited working time for the welding. Further, workers who are exposed to these dangerous working conditions should wear bulky and heavy protective clothing and safe equipment, which will be accompanied by severe limitations in behavior, viewing and workability. Under these circumstances, there is a need to develop welding head carriers suitable for use in welding the inner surfaces of tubes.

A conventional track-type welding head carrier operates in such a manner that a welding head moves along a track. When the welding head and the track are replaced with new models, however, the welding head carrier may be incompatible with the new models. This incompatibility requires modification of the welding head carrier and makes it impossible to use the welding head carrier any more.

In a conventional welding apparatus, welding operation is conducted while moving a welding head along an internal circular track. However, since the conventional welding apparatus has no function to move the welding head in the lengthwise direction of a tube, the track must be precisely mounted along a welding line to weld the inner surface of the tube along the welding line.

For these reasons, the conventional welding apparatus suffers from problems, such as inconvenience and difficulty in precisely installing the track. Further, when the welding head moves along the track in a friction manner, welding defects may occur due to uncontrollable slipping of the welding head from the track.

### SUMMARY OF THE INVENTION

Therefore, it is one object of the present invention to provide a welding head carrier suitable for use in welding the inner surface of a tube in which fixing units can be adjusted in length depending on the size of the tube, thus eliminating the need for the rebuilding or replacement of the welding head carrier, which results in cost reduction, and a welding head can be easily mounted, regardless of manufacturers of the welding head, thus achieving remarkably extended range of use.

It is another object of the present invention to provide a welding head carrier for use in welding the inner surface of a tube, which is configured to move a welding head in the lengthwise direction of the tube and to be rotatable in the circumferential direction of the tube such that a welding torch of the welding head can be easily adjusted to a welding line, thereby enabling precise welding of the inner surface of the tube.

It is still another object of the present invention to provide a welding head carrier for use in welding the inner surface of a tube in which it is possible to observe whether cables are entangled while monitoring the operation of the machine by using a camera.

In order to accomplish the objects of the present invention, there is provided a welding head carrier for use in welding the inner surface of a tube, which comprises: a universal chuck as a main body; a fixing unit attached to the universal chuck to fix the main body to the inner surface of the tube; a rotary motor to generate a driving force for welding the inner surface of the tube in the circumferential direction of the tube; a rotary driver for the transmission of the driving force from the rotary motor; a rotary cover to protect the rotary driver, to allow a forward/backward driving unit to be attached thereto, to receive the driving force transmitted from the rotary driver and to rotate in the circumferential direction of the tube; a rotary unit-attaching bar connected to the rotary cover; a forward/backward driving motor to generate a driving force for welding the inner surface of the tube in the lengthwise direction of the tube; a forward/backward driver to transmit a driving force of the forward/backward driving motor; a welding head provided with a welding torch and a camera and receiving the driving force transmitted from the forward/backward driver to move in the lengthwise direction of the tube; a motor controller for controlling the rotary motor and the forward/backward driving motor; a wireless camera mounted at the inner side of the tube to monitor whether cables are entangled; a wireless receiver for receiving wirelessly an image from the wireless camera; a camera controller for controlling the camera and the wireless receiver; and a display for displaying the welding operation of the welding torch and the inside of the tube according to the control of the camera controller.

The rotary driver comprises a pinion gear mounted on the rotary axis of the rotary motor and a main gear mounted to the rotary cover to be coupled with the pinion gear.

The fixing unit is mounted to the universal chuck so as to easily fix the main body to the inner surface of the tube. The length of the fixing unit is adjustable according to the size of the tube. Accordingly, the welding head carrier of the present invention can be applied to the welding of the inner surface of a tube, regardless of the size of the tube.

The fixing unit is comprised of two or more fixing units to serve to stably fix the main body to the inner surface of the tube.

The movements of the rotary motor and the forward/backward driving motor are remotely controlled and the rotational speeds thereof are controlled reversibly.

The welding head is connected to a welding machine to remotely weld the inner surface of the tube. The camera is comprised of two or more cameras to be arranged about the center of the welding torch. The welding operation of the welding head can be monitored on a display through the cameras.

The cameras are remotely controlled. Preferably, the cameras are connected to a cooling pump for circulating cooling water to prevent the cameras from being overheated during long-term use.

The forward/backward driver comprises a screw shaft rotated by the forward/backward driving motor, a nut bracket having a welding head attached thereto and coupled with the screw shaft to move on the screw shaft, guide shafts arranged in parallel with the screw shaft, and shaft bearings mounted on the guide shafts.

The rotary driver is supported by a fixing plate attached to the universal chuck.

### BRIEF DESCRIPTION OF THE DRAWING FIGURES

FIG. 1 is a schematic view illustrating the entire structure of a welding head carrier for the inner surface of a tube according to an embodiment of the present invention;

FIG. 2 is a right lateral view of a welding head carrier for the inner surface of a tube according to an embodiment of the present invention.

FIG. 3 is a perspective view illustrating the left side of a welding head carrier for the inner surface of a tube according to an embodiment of the present invention

FIG. 4 is a cross-sectional view illustrating a main part of the rotation of a welding head carrier according to an embodiment of the present invention in the circumferential direction of a tube.

FIG. 5 is a cross-sectional view illustrating a main part of the movement of a welding head carrier according to an embodiment of the present invention in the lengthwise direction of a tube; and.

FIG. 6 is a perspective view illustrating a welding head attached to a rotary cover in a welding head carrier according to an embodiment of the present invention in the lengthwise direction of the welding head.

### DETAILED DESCRIPTION OF THE PREFERRED EMBODIMENTS

Exemplary embodiments of the present invention will now be described in detail with reference to the accompanying drawings.

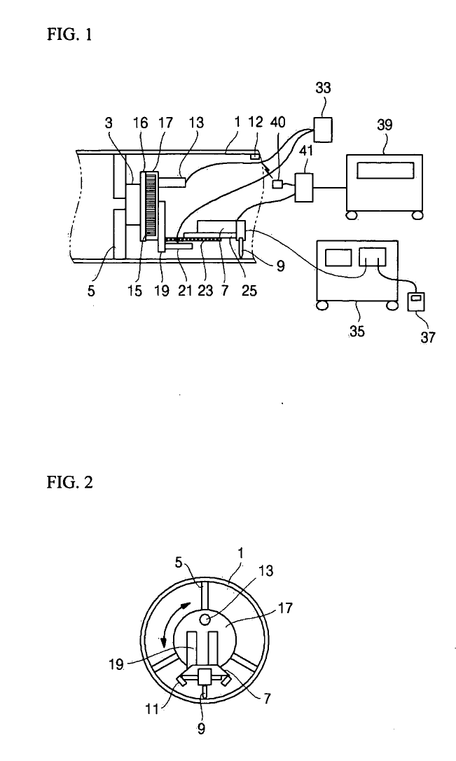

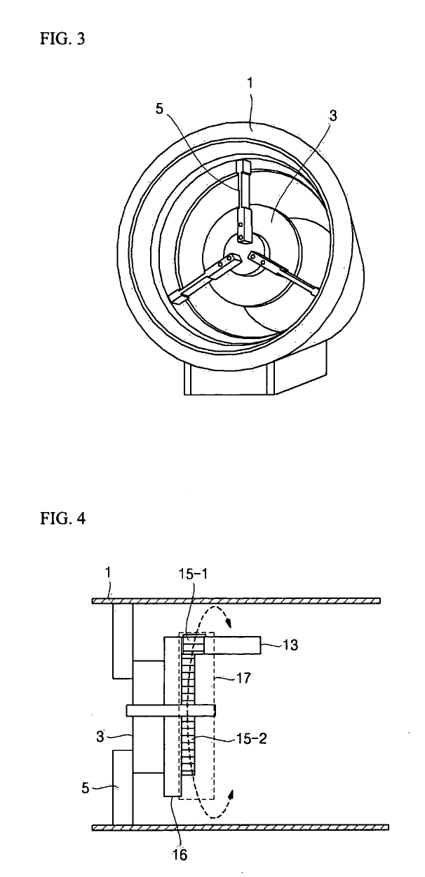

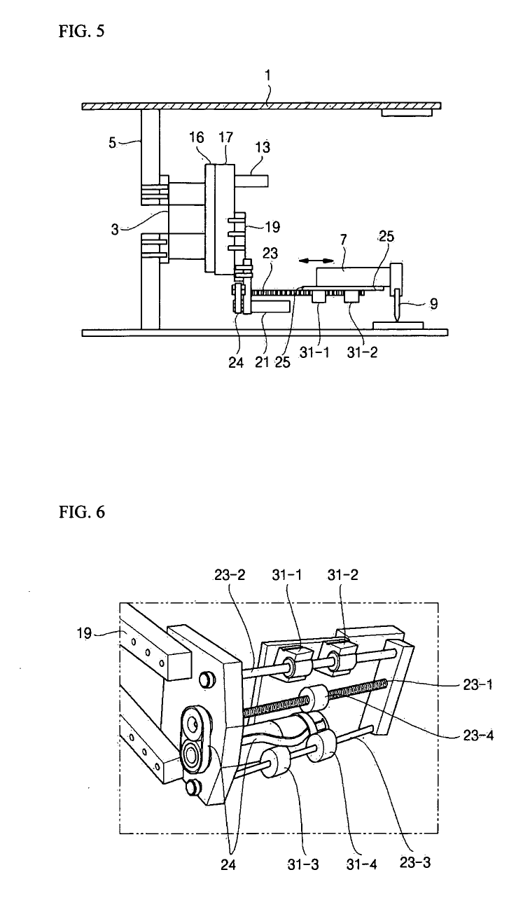

Referring to FIG. 1 to FIG. 6, the welding head carrier according to an embodiment of the present invention comprises: a universal chuck 3 as a main body; a plurality of fixing units 5 attached to the universal chuck 3 to fix the main body to the inner surface of the tube 1; a rotary motor 13 to generate a driving force for welding the inner surface of the tube 1 in the circumferential direction of the tube 1; a rotary driver 15 for the transmission of the driving force from the rotary motor 13; a rotary cover 17 to protect the rotary driver 15, to allow a forward/backward driving unit to be attached thereto, to receive the driving force transmitted from the rotary driver 15 and to rotate in the circumferential direction of the tube 1; a rotary unit-attaching bar 19 connected to the rotary cover 17; a forward/backward driving motor 21 to generate a driving force for welding the inner surface of the tube 1 in the lengthwise direction of the tube 1; a forward/backward driver 23 to transmit a driving force of the forward/backward driving motor 21; a welding head 7 provided with a welding torch 9 and a plurality of cameras 11 and receiving the driving force transmitted from the forward/backward driver 15 to move in the lengthwise direction of the tube 1; a motor controller 33 for controlling the rotary motor 13 and the forward/backward driving motor 21; a wireless camera 12 mounted at the inner side of the tube 1 to monitor whether cables are entangled; a wireless receiver 40 for receiving wirelessly an image from the wireless camera 12; a camera controller 41 for controlling the camera 11 and the wireless receiver 40; a display 39 for displaying the welding operation of the welding torch 9 and the inside of the tube 1 according to the control of the camera controller 41; a welding machine 35 for driving the welding torch 9; and a welding controller 37 for controlling the welding machine 35.

Hereinafter, the respective elements of the welding head carrier will be explained in detail.

The universal chuck 3 is a device for holding a regularly shaped workpiece by rotating a single handle to allow three jaws to move simultaneously at the same intervals. The universal chuck 3 as a main body is fixed to the tube 1.

The fixing units 5 are mounted to the universal chuck 3 so as to easily fix the main body to the inner surface of the tube 1. The lengths of the fixing units 5 are adjustable according to the size of the tube 1. Accordingly, the welding head carrier of the present invention can be applied to the welding of the inner surface of the tube 1, regardless of the size of the tube 1. The plurality of fixing units 5 serve to stably fix the main body to the inner surface of the tube 1.

The rotary motor 13 generates a driving force for the welding head 7 to be rotated for the welding of the tube 1 in the circumferential direction of the tube 1 and the movement thereof is remotely controlled by a motor controller 33. The rotational speed of the rotary motor 13 varies reversibly.

The motor controller 33 may be a free voltage controller.

The rotary driver 15 comprises a pinion gear 15-1 mounted on the rotary axis of the rotary motor 13 and a main gear 15-2 mounted to the rotary cover 17 to be coupled with the pinion gear 15-1.

The rotary cover 17 serves to protect the rotary driver 15. A forward/backward driving unit is attached to the rotary cover 17 through a rotary unit-attaching bar 19. The rotary cover 17 is preferably made of light aluminum in view of ease of installation.

The rotary unit-attaching bar 19 serves to stably attach the forward/driving unit to the rotary cover 17. A plurality of rotary unit-attaching bars may be provided in the welding head carrier of the present invention.

The forward/backward driving motor 21 generates a driving force for the welding head 7 to move the welding head carrier in the lengthwise direction of the tube 1 and the movement thereof is remotely controlled by the motor controller 33. The rotational speed of the forward/backward driving motor 21 varies reversibly.

The forward/backward driver 23 comprises a screw shaft 23-1 rotated by the forward/backward driving motor 21, a nut bracket 23-4 having a welding head 7 attached thereto and coupled with the screw shaft 23-1 to move on the screw shaft 23-1, guide shafts 23-2 and 23-3 arranged in parallel with the screw shaft 23-1, and shaft bearings 33-1, 33-2, 33-3 and 33-4 mounted on the guide shafts 23-2 and 23-3.

The welding torch 9 includes a mixing chamber in which oxygen and combustible gas are mixed with each other and a tip through which the gas mixture is discharged. Then, the gas mixture is ignited to weld the inner surface of the tube 1. The welding operation of the welding head can be monitored on a display through the cameras 11. The plurality of cameras 11 are arranged about the center of the welding torch 9.

The welding torch 9 of the welding head 7 is connected to a welding machine 35 and is remotely controlled by a welding controller 37 to weld the inner surface of the tube 1. The welding torch 9 may be made of tungsten.

The movements of the cameras 11 are remotely controlled by a camera controller 41. Preferably, the cameras 11 are connected to a cooling pump (not shown) for circulating cooling water to prevent the cameras 11 from being overheated during long-term use.

The wireless camera 12 is mounted at the inner side of the tube 1 to transmit wirelessly a monitoring image to the wireless receiver 40 while monitoring whether cables are entangled, and the wireless receiver 40 transmits the image transmitted from the wireless camera 12 to the camera controller 41.

The display 39 is formed to display the welding operation of the welding torch 9 and the inside of the tube 1 as well as entanglement of cables on the screen according to the control of the camera controller 41.

Referring to FIGS. 1 and 4, the welding process which the inner surface of the tube 1 is welded in the circumferential direction of the tube 1 is described.

The rotary driving motor 13 is actuated by the motor controller 33 to allow a pinion gear 15-1 of the rotary driver 15 to rotate a main gear 15-2 such that the rotary cover 17 coupled with the forward/driving unit rotates to weld the inner surface of the tube 1 in the circumferential direction of the tube 1.

Herein, the rotary driver 15 composed of the pinion gear 15-1 and the main gear 15-2 is supported by a fixing plate 16 attached to the universal chuck 3.

Referring to FIGS. 1, 5 and 6, the welding process which the inner surface of the tube 1 is welded in the lengthwise direction of the tube 1 is described.

When the forward/backward driving motor 21 is actuated by the motor controller 33, the driving force is transmitted through a power transmitting belt 24 to the forward/backward driver 23 to rotate a screw shaft 23-1. The screw shaft 23-1 is guided by guide shafts 23-2 and 23-3 to move the welding head carrier in the lengthwise direction of the tube 1 by a nut bracket 23-4 to which the welding head 7 is attached. The guide shafts 23-2 and 23-3 enable smooth forward/backward movement of the welding head carrier in association with shaft bearings 33-1, 33-2, 33-3 and 33-4.

As apparent from the foregoing, according to the welding head carrier of the present invention, the fixing units can be adjusted in length depending on the size of the tube, thus eliminating the need for the rebuilding or replacement of the welding head carrier. Therefore, the welding head carrier of the present invention is economically advantageous. In addition, since the welding head can be easily mounted, regardless of manufacturers of the welding head, the range of use of the welding head carrier can be remarkably extended.

Furthermore, the welding head carrier is configured to move the welding head in the lengthwise direction of the tube and to be rotatable in the circumferential direction of the tube such that the welding torch of the welding head can be easily adjusted to a welding line. Therefore, the use of the welding head carrier enables precise welding of the inner surface of the tube.

What is claimed is:

1. A welding head carrier for use in welding the inner surface of a tube, comprises:
a universal chuck as a main body;
a fixing unit attached to the universal chuck to fix the main body to the inner surface of the tube;
a rotary motor to generate a driving force for welding the inner surface of the tube in the circumferential direction of the tube;
a rotary driver for the transmission of the driving force from the rotary motor;
a rotary cover to protect the rotary driver, to allow a forward/backward driving unit to be attached thereto, to receive the driving force transmitted from the rotary driver and to rotate in the circumferential direction of the tube;
a rotary unit-attaching bar connected to the rotary cover;
a forward/backward driving motor to generate a driving force for welding the inner surface of the tube in the lengthwise direction of the tube;
a forward/backward driver to transmit a driving force of the forward/backward driving motor;
a welding head provided with a welding torch and a camera and receiving the driving force transmitted from the forward/backward driver to move in the lengthwise direction of the tube;
a motor controller for controlling the rotary motor and the forward/backward driving motor;
a wireless camera mounted at the inner side of the tube to monitor whether cables are entangled;
a wireless receiver for receiving wirelessly an image from the wireless camera;
a camera controller for controlling the camera and the wireless receiver; and
a display for displaying the welding operation of the welding torch and the inside of the tube according to the control of the camera controller.

2. The welding head carrier according to claim 1, wherein the rotary driver comprises a pinion gear mounted on the rotary axis of the rotary motor and a main gear mounted to the rotary cover to be coupled with the pinion gear.

3. The welding head carrier according to claim 1, wherein the length of the fixing unit is adjustable depending on the size of the tube to enable the welding head carrier to be applied to the welding of the inner surface of a tube, regardless of the size of the tube.

4. The welding head carrier according to claim 1, wherein the fixing unit is comprised of two or more fixing units to serve to stably fix the main body to the inner surface of the tube.

5. The welding head carrier according to claim 1, wherein the movements of the rotary motor and the forward/backward driving motor are remotely controlled and the rotational speeds thereof are controlled reversibly.

6. The welding head carrier according to claim 1, wherein the welding torch of the welding head is connected to a welding machine and the welding controller to remotely weld the inner surface of the tube.

7. The welding head carrier according to claim 1, wherein the camera is comprised of two or more cameras to be arranged about the center of the welding torch and the welding operation of the welding head is monitored on a display through the cameras.

8. The welding head carrier according to claim 1, wherein the forward/backward driver comprises a screw shaft rotated by the forward/backward driving motor, a nut bracket having a welding head attached thereto and coupled with the screw shaft to move on the screw shaft, guide shafts arranged in parallel with the screw shaft, and shaft bearings mounted on the guide shafts.

9. The welding head carrier according to claim 1, wherein the rotary driver is supported by a fixing plate attached to the universal chuck.
